(19) United States
(12) Patent Application Publication
(10) Pub. No.: US 2005/0210518 A1
(43) Pub. Date: Sep. 22, 2005

(54) Method for displaying thread of program in broadcasting receiver

(75) Inventor: Jin Kuk Jeong, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/081,550

(22) Filed: Mar. 17, 2005

(30) Foreign Application Priority Data
Mar. 19, 2004 (KR) 18790/2004

(51) Int. Cl. H04N 7/173; G06F 13/00; H04N 5/445; G06F 3/00

(52) U.S. Cl. 725/88; 725/39; 725/102

(57) ABSTRACT

When there is a request to display the thread of a program, a progress rate of the program that has been broadcast up to now is calculated, and the thread of portions of the program up to the calculated broadcasting progress rate is displayed. An electronic program guide (EPG) containing an event information table (EIT) in a broadcast signal is stored in a memory. When an instruction to display the thread of a program which is being viewed is inputted, a broadcasting progress rate of the program is calculated based on a start time and a broadcasting duration of the program, and a current time contained in the EIT. The thread of the portions of the program up to the calculated broadcasting progress rate is extracted from the EIT and then displayed.

### BACKGROUND OF THE INVENTION

1. Field of the Invention

The present invention relates to a method for displaying the thread of a program in a broadcasting receiver, wherein the thread of hitherto broadcast portions of a program that is being viewed can be displayed, so that a user can confirm the thread in a broadcasting receiver like a television set.

2. Description of the Related Art

With the development of digital technology, the digitalization of analog broadcast has been positively promoted at every country in the world. The transition of the analog broadcast to digital broadcast leads to multi-channel and high-quality broadcast. Digital television broadcast provides an electronic program guide (EPG) for allowing viewers to confirm information on broadcast programs, as well as video and audio signals that users can view and listen to.

Users of broadcasting receivers can obtain information on programs, which were broadcast or are scheduled to be broadcast over respective channels, using the EPG transmitted together with a digital television broadcast signal, and can select a channel for a desired program in the EPG to receive and view a desired broadcast. Further, the users can confirm the thread and the like of a program and also perform various kinds of functions including reserved recording.

The EPG contains an event information table (EIT), and the EIT contains information such as a program title event_id, a broadcast start_time start_time, a broadcast duration duration, a program thread descriptors and the like, as shown in FIG. 1.

When a user instructs a broadcasting receiver to display an EPG, the broadcasting receiver displays, on a display panel, for example, a plurality of broadcast channels and channel names 200, titles 210 of programs that are being currently broadcast over respective channels, and titles 220 of programs that will be subsequently broadcast, as shown in FIG. 2. When a cursor is placed on the position of the title of a program over a given channel, for example, a ‘The Story Of Tracy Beaker’ that is the title of a program which is being currently broadcast over ‘CBBC Channel’, the broadcasting receiver displays channel name 230 of ‘CBBC Channel’, current time 240, and broadcast duration 250 of the program, as well as the text thread of the program in a thread display area 260, so that the user confirms them.

In this case, the thread of the program displayed in the thread display area 260 is the whole thread of the program, and thus, the user can confirm both the thread of portions of the program that have been broadcast up to now and the thread of portions of the program that will be broadcast in the future.

Therefore, there is a problem in the prior art in that even when a user desires to confirm the thread of a program only up to an intermediate portion of the program while viewing the program from the intermediate portion thereof, the user is forced to confirm the whole thread of the program rather than the thread of only hitherto broadcast portions of the program, which diminishes curiosity on the thread of subsequent portions of the program.

### SUMMARY OF THE INVENTION

Accordingly, an object of the present invention is to provide a method for displaying the thread of a program in a broadcasting receiver, wherein upon input of a command for displaying the thread of a program, a current broadcasting progress rate of a program is determined, and the thread of only hitherto broadcast portions of the program corresponding to the determined current broadcasting progress rate is extracted and displayed.

Another object of the present invention is to provide a method for displaying the thread of a program in a broadcasting receiver, wherein if a program is a serial, the threads of pieces of the program that have been previously broadcast are displayed so that a user confirms the threads of the pieces of the program that have been broadcast from a first piece to a currently broadcast piece of the program.

According to an aspect of the present invention for achieving the objects, there is provided a method for displaying the thread of a program in a broadcasting receiver, comprising the steps of extracting an electronic program guide (EPG) from a received broadcast signal and storing the extracted EPG in a memory; if an instruction to display the EPG is inputted via a user interface, reading the EPG from the memory to display the read EPG on a screen by a central processing unit; if a program is selected on the displayed EPG and an instruction to display the thread of the program is inputted, calculating a broadcasting progress rate of the program using the EPG; and extracting the thread of portions of the program up to the calculated broadcasting progress rate from the EPG, and displaying the extracted thread.

According to another aspect of the present invention, there is provided a method for displaying the thread of a program in a broadcasting receiver, comprising the steps of receiving and demodulating, by a tuner/demodulator, a broadcast signal over a channel selected by a user, and extracting, by a demultiplexer, an AV stream from the demodulated signal, under control of a central processing unit, so that the user can view an image of the AV stream; extracting, by the demultiplexer, an electronic program guide (EPG) from the demodulated signal and storing the extracted EPG in a memory; simultaneously displaying a thread icon for use in instructing to display the thread, on a screen that displays the image of the AV stream; if a selection instruction through the thread icon is inputted via a user interface, calculating a broadcasting progress rate of a program that is being currently viewed, by using the EPG; and extracting the thread of portions of the program up to the calculated broadcasting progress rate from the EPG and displaying the extracted thread.

The step of calculating the broadcasting progress rate may comprise the step of extracting a start time and a broadcasting duration of the program, and a current time from an event information table (EIT) contained in the EPG to calculate the broadcasting progress rate. The step of extracting the thread of the portions of the program may comprise the step of extracting the thread of the portions of the program from an event information table (EIT) contained in the EPG. If the program is a serial, the step of displaying the thread of the portions of the program may comprise the step of simultaneously displaying the threads of previously broadcast pieces of the program.

The thread icon, the EPG and the thread may be displayed with on-screen display (OSD) signals.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates information contained in an EIT of an EPG;

FIG. 2 exemplarily illustrates a state where information contained in the EIT of the EPG is displayed on a screen;

FIG. 3 is a block diagram exemplarily showing a configuration of a broadcasting receiver to which a method for displaying the thread of a program according to the present invention is applied;

FIG. 4 is a flowchart illustrating a method for displaying the thread of a program according to an embodiment of the present invention;

FIG. 5 exemplarily illustrates an EIT that a broadcasting station provides by means of the method for displaying the thread of a program according to the present invention;

FIGS. 6a and 6b exemplarily illustrate states where a program is a one-act drama and the thread of the program is displayed depending on a program progress rate by means of the method for displaying the thread of a program according to the present invention;

FIGS. 7a and 7b exemplarily illustrate states where a program is a serial and the thread of the program is displayed depending on a program progress rate by means of the method for displaying the thread of a program according to the present invention;

FIG. 8 is a flowchart illustrating a method for displaying the thread of a program according to another embodiment of the present invention; and

FIG. 9 exemplarily illustrates a state where a thread display icon is displayed on a program display screen by means of the method for displaying the thread of a program according to the other embodiment of the present invention.

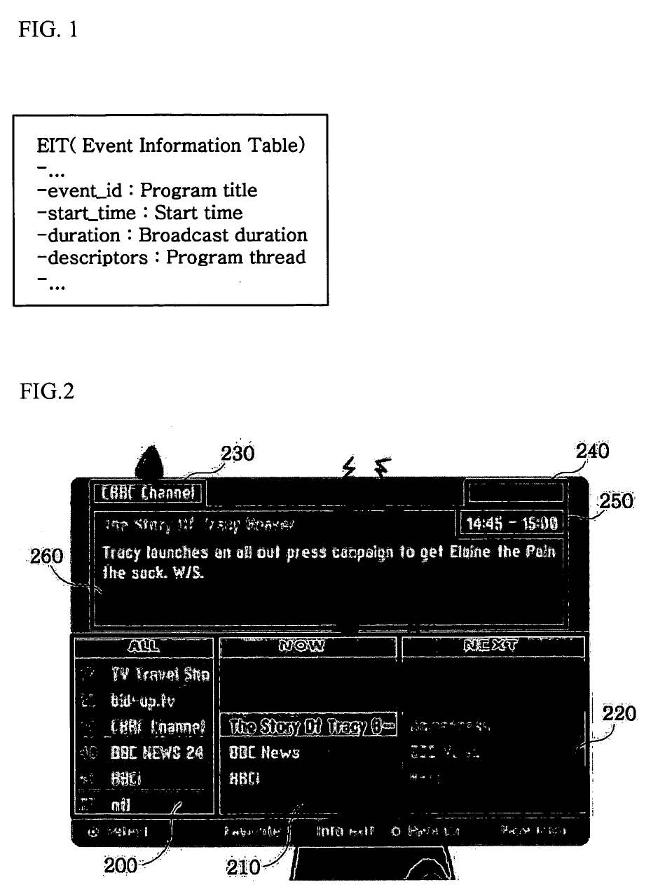

### DETAILED DESCRIPTION OF THE INVENTION

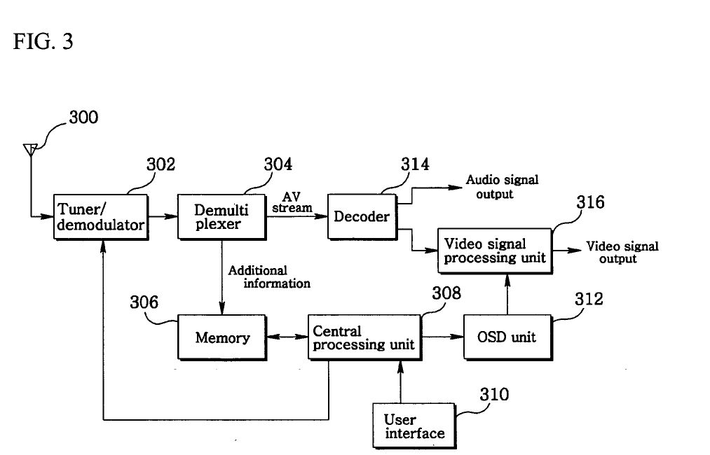

Hereinafter, a method for displaying the thread of a program according to the present invention will be described in detail with reference to the accompanying drawings, especially, FIGS. 3 to 9.

FIG. 3 is a block diagram showing a configuration of a broadcasting receiver to which a method for displaying the thread of a program according to the present invention is applied. As shown in the figure, the broadcasting receiver comprises a tuner/demodulator 302 for tuning and demodulating a broadcast signal over a prescribed channel among broadcast signals received via an antenna 300; a demultiplexer 304 for demultiplexing an AV stream and additional information containing an EPG from an output signal of the tuner/demodulator 304; a memory 306 for storing the additional information demultiplexed by the demultiplexer 304 therein; a central processing unit 308 for controlling an overall operation of the broadcasting receiver and the display of the additional information stored in the memory 306; a user interface 310 for inputting an operation instruction into the central processing unit 308 in response to a user's operation; an on-screen display (OSD) unit 312 for generating an OSD signal under the control of the central processing unit 308; a decoder 314 for decoding the AV stream demultiplexed by the demultiplexer 314 to generate an audio signal and a video signal; and a video signal processing unit 316 for mixing and outputting the video signal from the decoder 314 and the OSD signal from the OSD unit 312.

In the broadcasting receiver constructed as above, the tuner/demodulator 302 tunes and demodulates a broadcast signal over a prescribed channel among broadcast signals received via the antenna 300 under the control of the central processing unit 308. The demultiplexer 304 demultiplexes the AV stream and the additional information from the demodulated signal, and the demultiplexed additional information is stored in the memory 306.

The decoder 314 decodes the AV stream, which has been demultiplexed by the demultiplexer 304, to output an audio signal and a video signal, and the video signal processing unit 316 processes the video signal and outputs the processed video signal, so that a user views the broadcast over the prescribed channel.

When the user instructs, via the user interface 310, the central processing unit 308 to display the EPG, the central processing unit 308 reads the EPG from the memory 306 and controls the OSD unit 312 according to the read EPG to generate an OSD signal of the EPG. The generated OSD signal is outputted via the video signal processing unit 316, so that the user confirms the EPG which is displayed on a display panel.

In this situation, when the user places a cursor on a desired program on the EPG while moving the cursor within the EPG displayed on the display panel, and then instructs the central processing unit 308 to display the thread, the central processing unit 308 reads the thread of the program from the memory 306 and controls the OSD unit 312 according to the read thread to generate the OSD signal. The generated OSD signal is outputted via the video signal processing unit 316 and is displayed on the display panel, so that the user confirms the OSD.

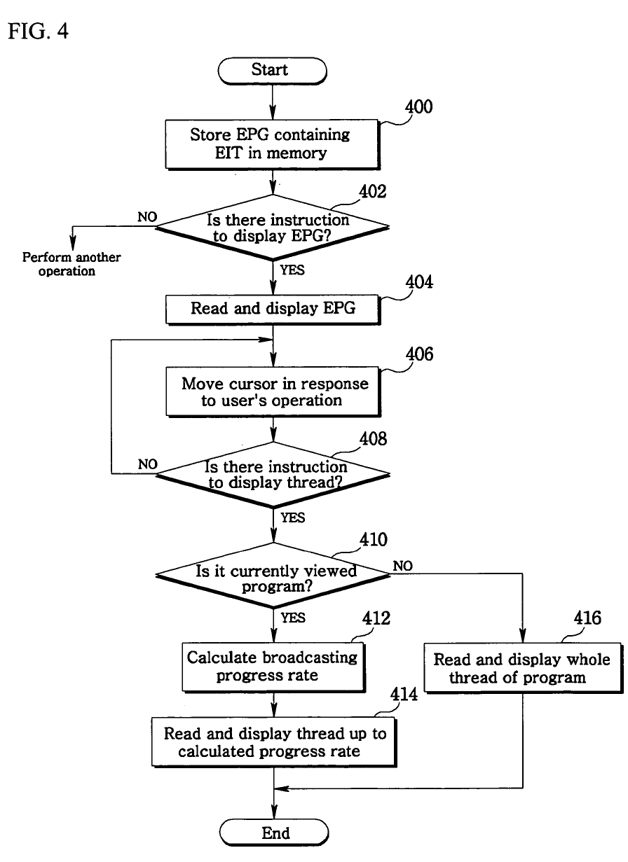

FIG. 4 is a flowchart illustrating a method for displaying the thread of a program according to an embodiment of the present invention. As shown in the figure, EPG information containing an EIT, which is demultiplexed by the demultiplexer 304 from the broadcast signal that is received and demodulated by the tuner/demodulator 302, is stored in the memory 306 (step 400).

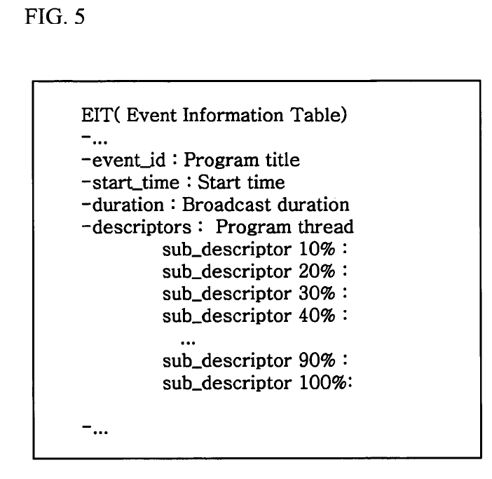

The EPG is generated and broadcast together with the broadcast signal by a broadcasting station. Before the broadcasting station broadcasts the EIT within the EPG, for example, the broadcasting station classifies the threads of a predetermined program depending on a progress rate of the program and inserts the threads into the EIT if the program is a one-act drama; or the broadcasting station classifies threads up to previously broadcast pieces of a program on a piece basis and inserts the threads into the EIT, and simultaneously classifies threads depending on a broadcasting progress rate of a currently broadcast piece of the program and inserts the threads into the EIT if the program is a serial, as shown in FIG. 5.

When the user instructs, via the user interface 310, the central processing unit 308 to display the EPG (step 402), the central processing unit 308 reads the EPG that has been stored in the memory 306 and controls the OSD unit 312 according to the read EPG so as to generate the OSD signal and display the EPG on the screen of the display panel (step 404).

The central processing unit 308 moves the cursor on the EPG display screen in response to a cursor movement instruction or the like which is received via the user interface 310 (step 406). The central processing unit 308 determines whether the user instructs the central processing unit 308 to display the thread of a predetermined program after the user places the cursor on the program (step 408).

If it is determined in step 408 that the user instructs the central processing unit 308 to display the thread, the central processing unit 308 determines whether the program on which the cursor is placed is a currently viewed program (step 410). If the program is determined to be a currently viewed program, the central processing unit 308 calculates a broadcasting progress rate of the program up to now (step 412). That is, the central processing unit 308 calculates how much percentage of the program has been broadcast, based on the start time and the broadcasting duration of the program, and the current time in the EIT.

Here, the calculated broadcasting progress rate is adjusted based on a broadcasting progress of the thread of the program that has been provided in the EIT. For example, if the thread provided in the EIT has been classified according to broadcasting progress rates of 10%, 20%, . . . , 100%, the central processing unit 308 adjusts the broadcasting progress rate by rounding off the calculated broadcasting progress rate to the nearest ten. Hereinafter ‘calculated’ is broadly referred to as ‘adjusted’.

When the broadcasting progress rate of the program has been calculated, the central processing unit 308 reads the thread of portions of the program up to the calculated broadcasting progress rate from the EIT (step 414) and controls the OSD unit 312 according to the read thread to generate an OSD signal. The OSD signal of the generated thread is outputted via the video signal processing unit 316 and is displayed on the screen of the display panel, so that the user confirms the thread of the portions of the program which have been broadcasted up to now.

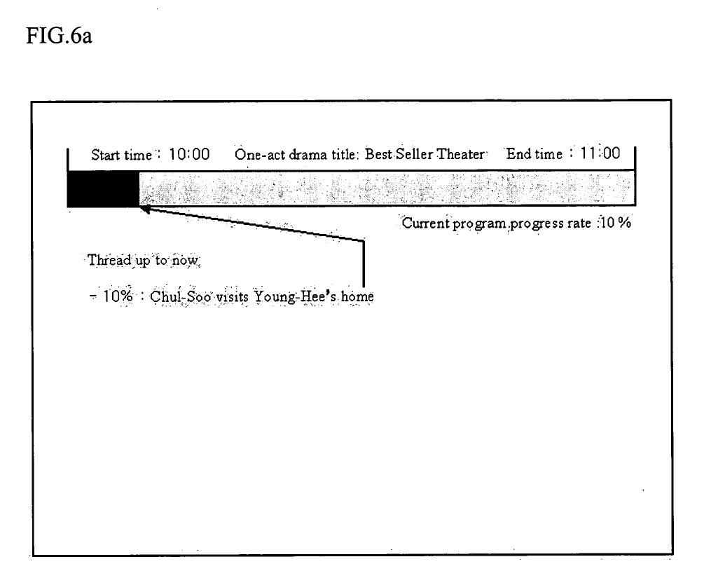

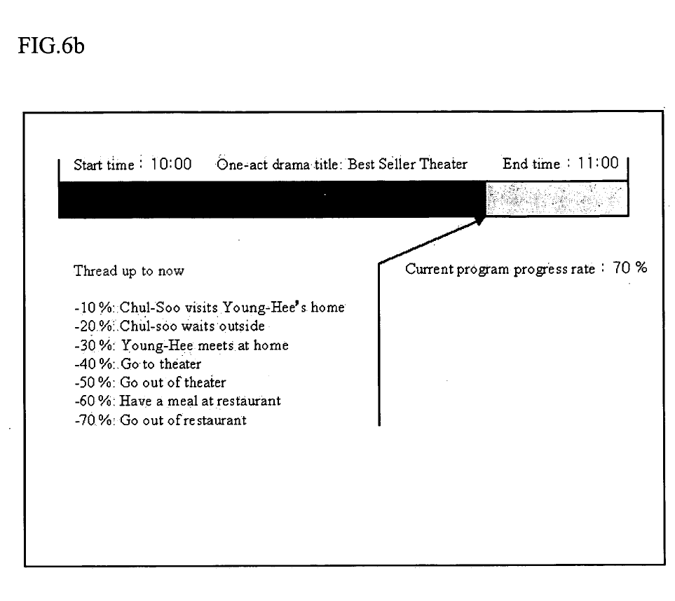

For example, if the program is a one-act drama and the progress rate of the program is 10%, the thread of only portions of the program corresponding to 10% of the program is displayed as shown in FIG. 6a. If the progress rate of the program is 70%, the thread of portions of the program corresponding to 70% of the program is displayed as shown in FIG. 6b.

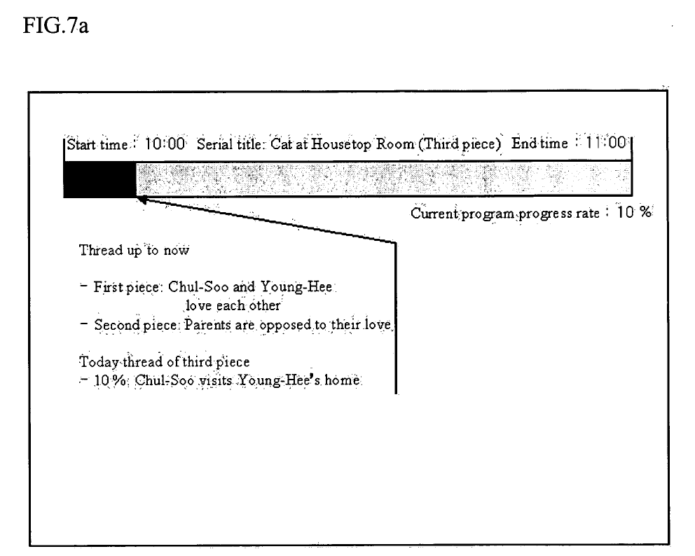

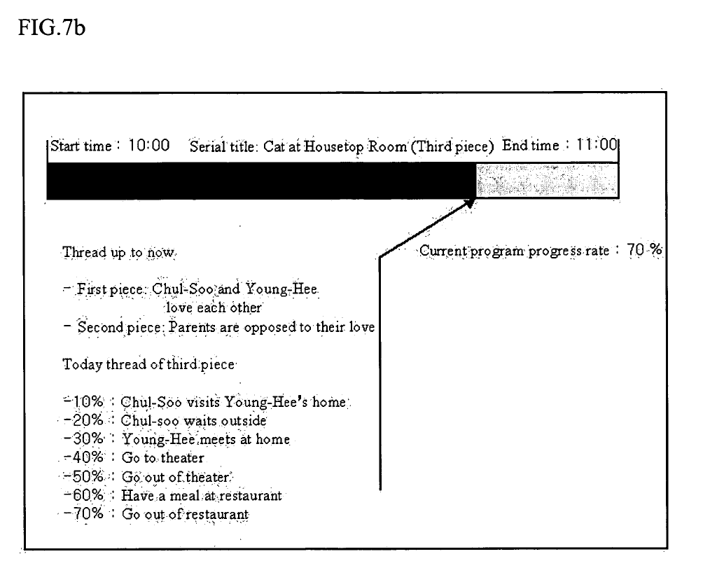

If the program is a serial and the progress rate of the program is 10%, both the threads of previously broadcast pieces of the program and the thread of only portions of a currently broadcast piece of the program corresponding to 10% of the currently broadcast piece are displayed, as shown in FIG. 7a. If the progress rate of the program is 70%, the threads of the previously broadcast pieces of the program and the thread of only portions of the currently broadcast piece of the program corresponding to 70% of the currently broadcast piece are displayed, as shown in FIG. 7b.

If it is determined in step 408 that the program is not a currently viewed program, the central processing unit 308 reads the whole thread of the program from the EIT and controls the OSD unit 312 according to the read whole thread to display the whole thread of the program (step 416).

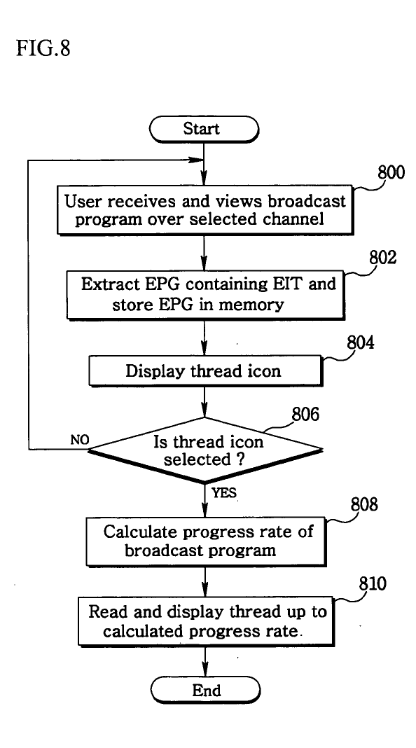

FIG. 8 is a flowchart illustrating a method for displaying the thread of a program according to another embodiment of the present invention. As shown in the figure, the central processing unit 308 causes the tuner/demodulator 302 to receive and demodulate a broadcast program over a channel selected by a user, the demultiplexer 304 to demultiplex the demodulated broadcast program, and the decoder 314 to decode the demultiplexed broadcast program, so that the user views the broadcasting (step 800). The demultiplexer 304 demultiplexes the EPG information containing the EIT and the demultiplexed EPG information is stored in the memory 306 (step 802).

The central processing unit 308 then controls the OSD unit 312 to generate an OSD signal of a thread icon, and the generated OSD signal of the thread icon is mixed with the video signal at the video signal processing unit 316 and is displayed on the display panel (step 804).

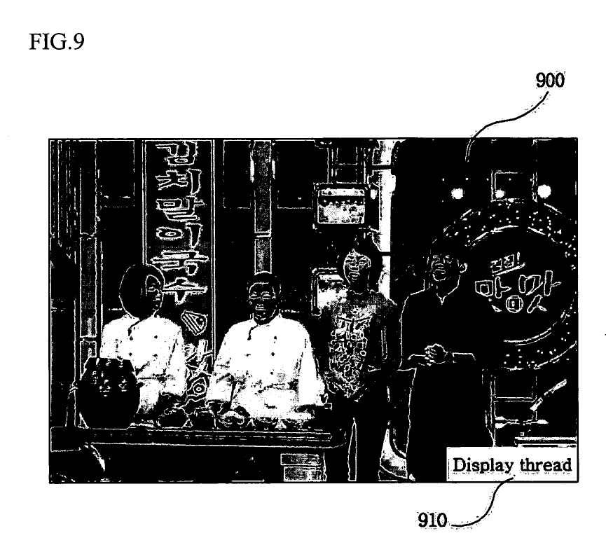

For example, as shown in FIG. 9, a thread icon 910 is displayed on a lower right portion of a display panel 900 on which an image of the program is displayed.

The central processing unit 308 determines whether the user selects the thread icon 910 via the user interface 310 (step 806). If it is determined that the user selects the thread icon 910, the central processing unit 308 calculates the progress rate of the broadcast program that is being currently viewed by the user (step 808). That is, as in the aforementioned embodiment, the central processing unit 308 calculates how much percentage of the program has been broadcast, based on the start time and the broadcasting duration of the program, and the current time in the EIT.

When the broadcasting progress rate of the program has been calculated, the central processing unit 308 reads the thread of portions of the program up to the calculated broadcasting progress rate from the EIT, and controls the OSD unit 312 according to the read thread to generate an OSD signal. The generated OSD signal of the thread is outputted via the video signal processing unit 316 and is displayed on the screen of the display panel, so that the user confirms the thread of the portions of the program which have been broadcast up to now (step 810).

According to the present invention described above, when a user requests to display the thread of a currently viewed program, a broadcasting progress rate is calculated and the thread of only portions of the program up to the calculated broadcasting progress rate is extracted and displayed if the broadcast program is a one-act drama, or both the threads of previously broadcast pieces of the program and the thread of only portions of a currently broadcast piece of the program up to the current broadcasting progress rate are extracted and displayed if the program is a serial. Therefore, there are advantages in that even though the user starts to view a program from an intermediate portion thereof, the user simply confirms the thread or threads of previously broadcast portions or pieces of the program but cannot know the thread or threads of subsequently broadcast portions or pieces of the program, whereby the user is led to continuous viewing of the program with curiosity.

Although the present invention has been shown and described in connection with the preferred embodiments of the present invention, it will be readily understood by those skilled in the art that various modifications and changes can be made thereto without departing from the spirit and scope of the present invention defined by the appended claims.

1. A method for displaying the thread of a program in a broadcasting receiver, comprising the steps of:
extracting an electronic program guide (EPG) from a received broadcast signal and storing the extracted EPG in a memory;
if an instruction to display the EPG is inputted via a user interface, reading the EPG from the memory to display the read EPG on a screen by a central processing unit;
if a program is selected on the displayed EPG and an instruction to display the thread of the program is inputted, calculating a broadcasting progress rate of the program using the EPG; and
extracting the thread of portions of the program up to the calculated broadcasting progress rate from the EPG, and displaying the extracted thread.

2. The method as claimed in claim 1, wherein the step of calculating the broadcasting progress rate comprises the step of:
extracting a start time and a broadcasting duration of the program, and a current time from an event information table (EIT) contained in the EPG to calculate the broadcasting progress rate.

3. The method as claimed in claim 1, wherein the step of extracting the thread of the portions of program comprises step of:
extracting the thread of the portions of the program from an event information table (EIT) contained in the EPG.

4. The method as claimed in claim 1, wherein if the program is a serial, the step of displaying the thread of the portions of the program comprises the step of:
simultaneously displaying the threads of previously broadcast pieces of the program.

5. The method as claimed in claim 1, further comprising the step of:
if an instruction to display the thread of a program which is not being currently viewed is inputted, extracting the whole thread of the program from the EPG and display the extracted whole thread.

6. The method as claimed in claim 5, wherein the step of extracting the whole thread of the program comprises the step of:
extracting the whole thread of the program from an event information table (EIT) contained in the EPG.

7. The method as claimed in claim 1, wherein the EPG and the thread are displayed with on-screen display (OSD) signals.

8. A method for displaying the thread of a program in a broadcasting receiver, comprising the steps of:
receiving and demodulating, by a tuner/demodulator, a broadcast signal over a channel selected by a user, and extracting, by a demultiplexer, an AV stream from the demodulated signal, under the control of a central processing unit, so that the user can view an image of the AV stream;
extracting, by the demultiplexer, an electronic program guide (EPG) from the demodulated signal and storing the extracted EPG in a memory;
simultaneously displaying a thread icon for use in instructing to display the thread, on a screen that displays the image of the AV stream;
if a selection instruction through the thread icon is inputted via a user interface, calculating a broadcasting progress rate of a program that is being currently viewed, by using the EPG; and
extracting the thread of portions of the program up to the calculated broadcasting progress rate from the EPG and displaying the extracted thread.

9. The method as claimed in claim 8, wherein the step of calculating the broadcasting progress rate comprises the step of:
extracting a start time and a broadcasting duration of the program, and a current time from an event information table (EIT) contained in the EPG to calculate the broadcasting progress rate.

10. The method as claimed in claim 8, wherein the step of extracting the thread of the portions of the program comprises step of:
extracting the thread of the portions of the program from an event information table (EIT) contained in the EPG.

11. The method as claimed in claim 8, wherein if the program is a serial, the step of displaying the thread of the portions of the program comprises the step of:
simultaneously displaying the threads of previously broadcast pieces of the program.

12. The method as claimed in claim 8, wherein the thread icon, the EPG and the thread are displayed with on-screen display (OSD) signals.
